(19) United States
(12) Patent Application Publication
(10) Pub. No.: US 2020/0026103 A1
(43) Pub. Date: Jan. 23, 2020

(54) Adjustable Window Transparency Control System

(71) Applicant: Alan Logan, Philadelphia, PA (US)

(72) Inventor: Alan Logan, Philadelphia, PA (US)

(21) Appl. No.: 16/505,801

(22) Filed: Jul. 9, 2019

Related U.S. Application Data
(60) Provisional application No. 62/699,282, filed on Jul. 17, 2018.

(51) Int. Cl. G02F 1/01; B60J 3/04; E06B 9/24

(52) U.S. Cl. CPC G02F 1/0121; B60J 1/02; E06B 9/24; B60J 3/04

(57) ABSTRACT

A window transparency control system. The window transparency control system has at least one window that is adjustably transparent upon receipt of electrical current. At least one wire is disposed around the circumference of the windows and is electrically connected to the windows. A controller is electrically connected to the wires. The controller is also electrically connected to a power source such that an individual can selectively control the amount of current flowing through the wires into the windows via the controller and therefore the transparency of the windows. In one embodiment, an input console is wirelessly connected to one or more processors. The one or more processors are operably connected to the wires such than an individual can selectively control the amount of current flowing through the wires into the windows via the wireless input console.

### CROSS REFERENCE TO RELATED APPLICATIONS

This application claims the benefit of U.S. Provisional Application No. 62/699,282 filed on Jul. 17, 2018. The above identified patent application is herein incorporated by reference in its entirety to provide continuity of disclosure.

### BACKGROUND OF THE INVENTION

The present invention relates to window transparency systems. More particularly, the present invention provides an adjustable window transparency control system that includes at least one wire along the perimeter of at least one window, wherein the adjustable window transparency control system is configured to allow a user to selectively adjust the level of transparency through the at least one window.

Many people enjoy looking through a window in order to take in their surroundings, be it in a house, office or through the windshield of their car. On sunny and hot days, the bright light and heat that can pass through the window can be too much. The glare alone can be distracting and detract from the views afforded by the window. Additionally, some people are sensitive to direct sunlight and take precautions to avoid the sun's damaging rays. Direct light may also fade and damage sensitive fabrics. To combat such problems, such an individual may need to resort to shielding their eyes, either by closing blinds or putting down a sun-shade, either option resulting in the impairment or blockage of their view. In an alternative, such an individual can put on sunglasses, which will allow them to see, but which may not be readily available and does not address the problem of the damaging effects of the sun on other parts of the individual's body or environment.

Devices have been disclosed in the known art that relate to window transparency systems. These window transparency systems have been patented and disclosed in patent application publications. However, the devices have several drawbacks. For example, such systems typically include either a film or series of filters attached to the window, which must be specially manufactured, and which are susceptible to cracking, bubbling or peeling away from the surface. Accordingly, an adjustable window transparency control system that allows a user to selectively adjust the level of transparency through the window, thereby reducing or eliminating the amount of lights, UV rays, and glare is desired.

The present invention substantially diverges in design elements from the known art and consequently it is clear that there is a need in the art for an improvement to existing window transparency control systems. In this regard the present invention substantially fulfills these needs.

### SUMMARY OF THE INVENTION

In view of the foregoing disadvantages inherent in the known types of window transparency systems now present in the prior art, the present invention provides for an adjustable window transparency control system that includes at least one wire along the perimeter of at least one window, wherein the adjustable window transparency control system is configured to allow a user to selectively adjust the level of transparency through the at least one window. The present window transparency control system comprises at least one window that is adjustably transparent upon receipt of electrical current. At least one wire is disposed around the circumference of the window and is electrically connected to the window. A controller is electrically connected to the wires. The controller is also electrically connected to a power source such that an individual is able to selectively control the amount of current flowing through the wire into the window via the controller and therefore the transparency of the window. In one embodiment, an input console is wirelessly connected to one or more processors. The one or more processors are operably connected to the wires such than an individual can selectively control the amount of current flowing through the wires into the window via the wireless input console.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the window transparency control system disposed on a car.

FIG. 2 shows a perspective view of an embodiment of the window transparency control system.

FIG. 3A shows a perspective view of an embodiment of the input console disposed on the dashboard of a car.

FIG. 3B shows a frontal view of an embodiment of the input console disposed on a key fob.

FIG. 3C shows a frontal view of an embodiment of the input console disposed on a cell phone.

FIG. 4 shows a block diagram of the representative electronic components of an embodiment of the window transparency control system.

FIG. 5 shows a block diagram of the representative electronic components of an embodiment of the window transparency control system incorporating a wireless input console.

### DETAILED DESCRIPTION OF THE INVENTION

Reference is made herein to the attached drawings. Like reference numerals are used throughout the drawings to depict like or similar elements of the window transparency control system. For the purposes of presenting a brief and clear description of the present invention, a preferred embodiment will be discussed as used for the window transparency control system. The figures are intended for representative purposes only and should not be considered to be limiting in any respect.

As used herein, “logic” refers to (i) logic implemented as computer instructions and/or data within one or more computer processes and/or logic (ii) logic implemented in electronic circuitry. As used herein, “computer readable medium” excludes any transitory signals, but includes any non-transitory data storage circuitry, e.g., buffers, cache, and queues, within transceivers of transitory signals.

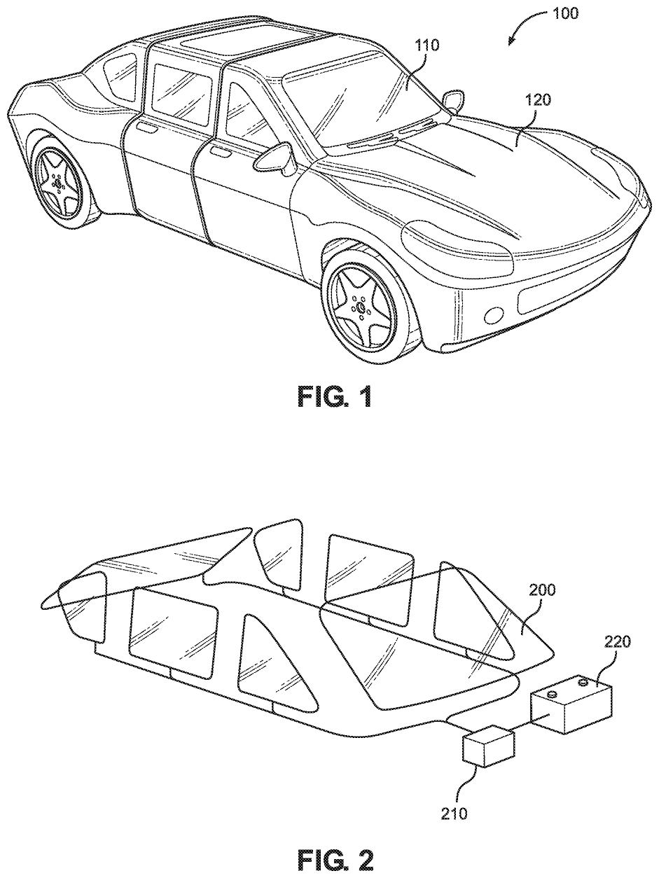

Referring now to FIG. 1, there is shown a perspective view of an embodiment of the window transparency control system disposed on a car. The adjustable window transparency control system 100 is configured to allow a user to selectively adjust the level of transparency through at least one window 110. It should be understood by one of ordinary skill in the art that the window transparency control system 100 can be disposed on any window including, but not limited to, windows in a house, office, or other structures. The window transparency control system 100 is also not limited to external-facing windows and may be disposed on the internal windows of a structure as well.

In one embodiment, the default state of the window 110 is completely opaque. This default state of having the window 110 opaque provides many benefits. Where the window 110 is in a house or office, and is an internal window 110, the opaque window 110 provides privacy to the user by eliminating the ability of a third party to look through the window 110. In this manner a user can create a private space for conversations or meetings. Where the window 110 is an external window 110, the opaque window 110 provides protection from the sun's harmful rays, glare and heat. In particular, the reduction in heat provides the benefit of cutting down on cooling costs for the home, office or structure.

When electrical current is passed through the window transparency control system 100 into the window 110, the window 110 is configured to become adjustably transparent. Several methods of selectively adjusting the opacity and transparency of a window are available. In some embodiments, the passage of current through a crystal lattice causes the crystals to align and allow light to pass through. Where only some of the crystals align, only a portion of the light passes through, thereby resulting in a partially opaque window. Some inventions currently used in the art rely on film layers disposed on the surface of the window, wherein electric current initiates a chemical reaction in the film resulting in a molecular structure that changes, resulting in a lightening or darkening of the film. In some embodiments, a similar chemical structure can be imbued in the window, such that passage of current by at least one wire into the window results in the lightening or darkening of the window. In such manners, the amount of current passing through the window transparency control system 100 into the window 110 determines the level of transparency of the window 110. In such a manner, a user can selectively determine the level of transparency of the window 110 ranging from completely transparent to completely opaque.

In the shown embodiment the window transparency control system 100 is disposed in a car 120, thereby allowing the user to selectively adjust the level of transparency of the windows 110 in the car 120. In a further embodiment, the window transparency control system 100 can be disposed on multiple windows 110, whereby each window 110 is independently controlled, as further detailed below. In such an embodiment, a user can selectively adjust the level of transparency of each individual window 110.

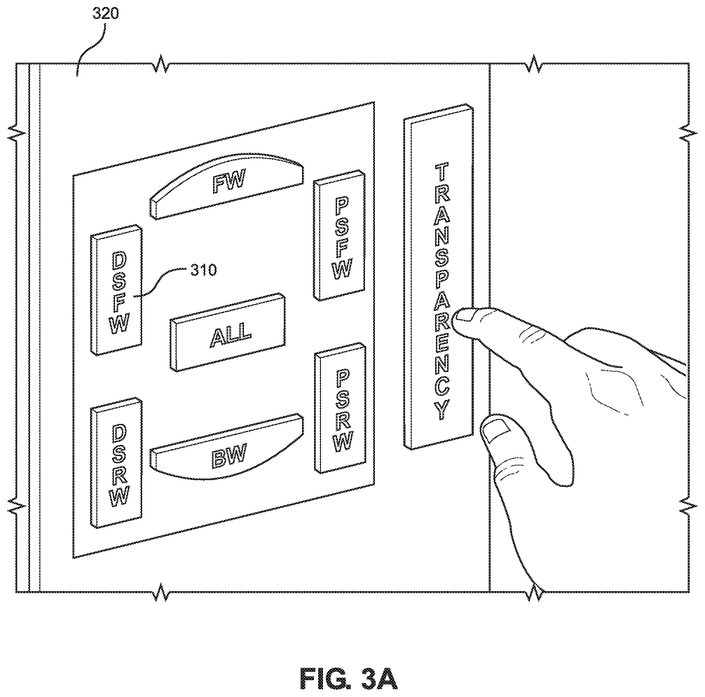

Referring now to FIG. 2, there is shown a perspective view of an embodiment of the window transparency control system disposed in a car. In the shown embodiment, the at least one wire 200 is disposed entirely around the circumference of the windows. In one embodiment, the wires 200 are low profile and lay flat against the circumference of the windows. In another embodiment, the wires 200 are received by a channel in the circumference of the widows such that a top of the wires rest flush with the remainder of the circumference of the windows. The wires 200 are interconnected and are in electrical communication with a controller 210, as described below. In one embodiment, the wires 200 are transparent. The transparent nature of the wires allows for the wires to be disposed around the windows such that they are not able to be seen, allowing the windows to remain aesthetically pleasing. In another embodiment, the plurality of wires 200 are low-profile such that they can be positioned in a manner that will not impede the user's view through the window or interfere with the operation of rolling the window up or down.

The wires 200 are disposed around the circumference of the window and are connected to a controller 210. The controller 210, in turn, is electrically connected to a power source 220. The controller 210 controls the flow of electricity from the power source 220 to the window transparency control system thereby controlling the level of transparency of the window. In one embodiment, the power source 220 is a pre-existing electrical power source such as an electric outlet in a building or a car battery. Where the window transparency control system is disposed in a building, the electric outlet enables a constant supply of electricity to be available. Where the window transparency control system is disposed in a car, the car battery supplies the electricity. In one embodiment, the controller is configured to keep the front windshield window partially transparent when the car is turned on and electricity is flowing therethrough. In a further embodiment, the controller is operably connected to the car's engine in order to determine when the car is running or idle.

In alternate embodiments, an independent power supply is electrically connected to the controller 210, such that in the case of a loss of power to the building or car, the window transparency control system is still able to supply electric current to the window. In embodiments where the default state of the window is opaque, the maintained supply of electricity allows the window to remain transparent. In various embodiments, such an independent power supply is also electrically connected to the pre-existing electrical power source in parallel in order to maintain the independent power supply at full charge.

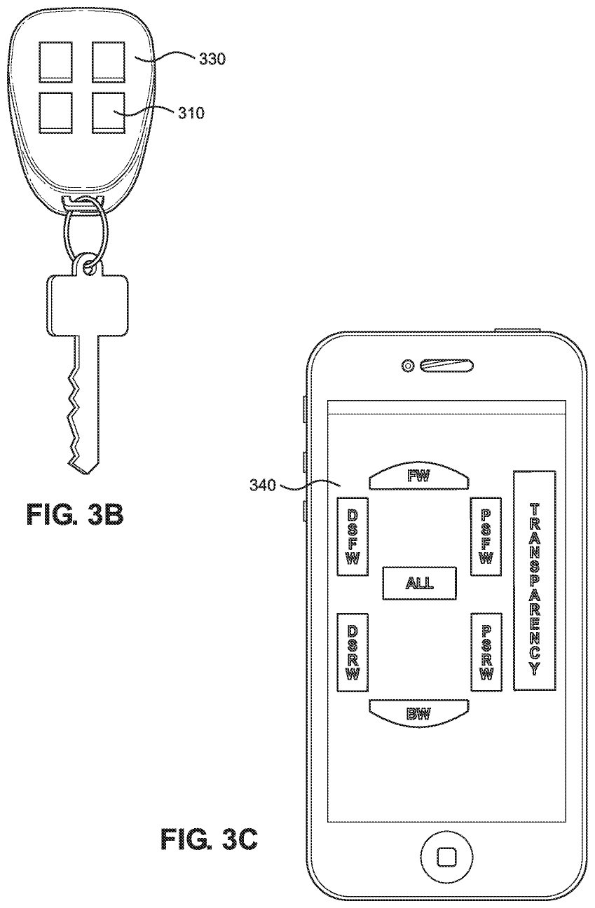

Referring now to FIG. 3A, there is shown a perspective view of an embodiment of an input console disposed on the dashboard of a car. The controller 210 is operably connected to an input console 300. In the shown embodiment, the input console 300 comprises a plurality of buttons 310 disposed on the dashboard 320 of a car. The plurality of buttons 310 correspond to each of the windows of the car (driver-side front window “DSFW”, passenger-side front window “PSFW”, driver-side rear window “DSRW”, and passenger-side rear window “PSRW”) and a transparency adjustment button which allows the user to selectively adjust the transparency of the corresponding window 110.

Referring now to FIG. 3B and FIG. 3C, there are shown frontal views of embodiments of the input console disposed on a key fob and cellphone. In one embodiment, the input console 300 comprises a plurality of physical buttons 310 disposed on a key fob 330 that are capable of being depressed. The key fob 330 is wirelessly connected to the controller 210 via a wireless transceiver. The key fob 330 provides a means for controlling the window transparency control system in such a manner that the user does not need to be near the window and allows the user to remotely control the window transparency control system. Similarly, in another embodiment the input console 300 is a cellphone 340. The cellphone 340 allows the user to control the window transparency control system 100 remotely in the same manner as the dashboard input console or the key fob, without having to be in the car, as is the case with the dashboard input console, or carry a separate control unit such as a key fob 330.

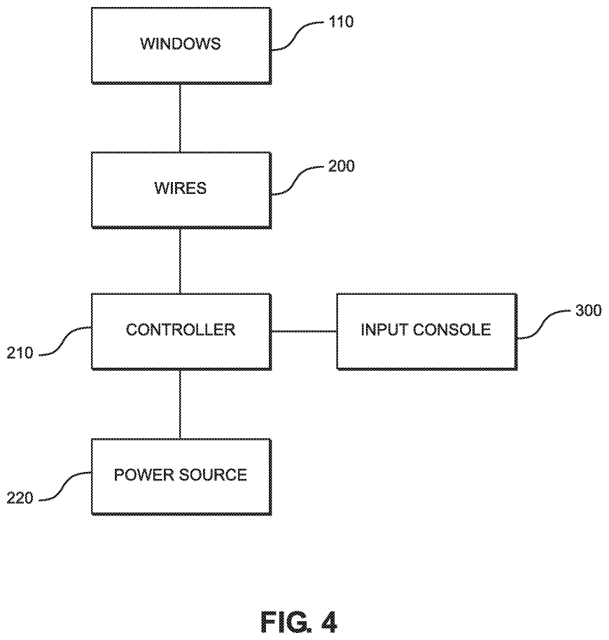

Referring now to FIG. 4, there is shown a block diagram of the representative electronic components of an embodiment of the window transparency control system. The window transparency control system comprises at least one window 110 configured to receive at least one wire 200. The wires 200 are physically and electrically connected to the windows 110. Additionally, the wires 200 are operably connected to a controller 210. The controller 210 is in turn operably connected to an input console 300 and the controller 210 is electrically connected to a power source 220. The controller 210 regulates the amount of current passing through the window transparency control system 100 into the window 110 which determines the level of transparency of the window 110. In such a manner a user can selectively determine the level of transparency of the window 110 from completely transparent to completely opaque, and various stages in-between.

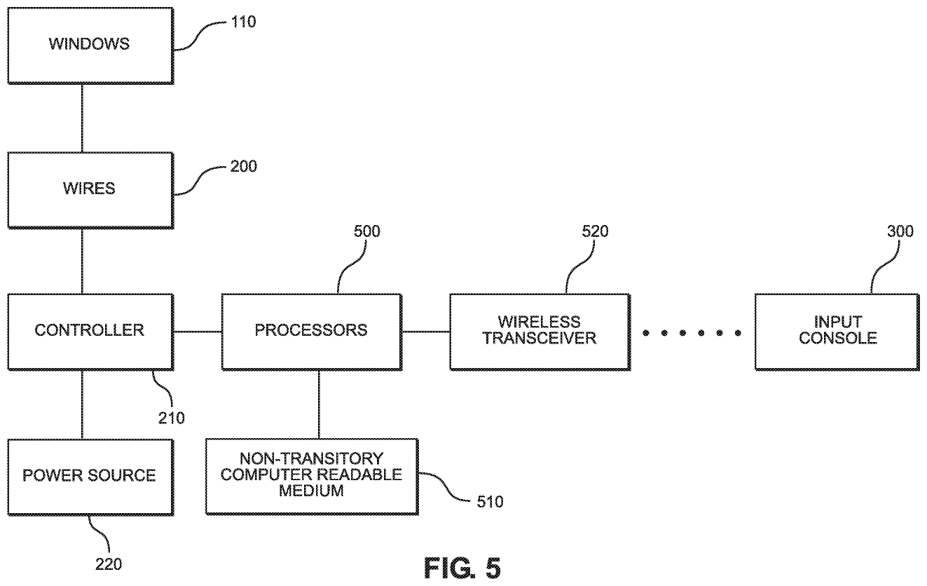

Referring now to FIG. 5, there is shown a block diagram of the representative electronic components of an embodiment of the window transparency control system incorporating a wireless input console. In the shown embodiment, the input console 300 is wirelessly connected to a wireless transceiver 520. The wireless transceiver 520 is operably connected to one or more processors 500. The one or more processors 500 are in turn operably connected to the controller 210 and a non-transitory computer readable medium 510. A logic is stored in the non-transitory computer readable medium that when executed causes the power source 220 to adjustably pass current to the plurality of wires 200 via the controller 210 to the windows 110. In such a manner, a user is able to selectively control the amount of current that passes from the power source 220 through to the windows 110, resulting in various levels of transparency and opacity being achieved.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A window transparency control system, comprising:
at least one window configured to be adjustably transparent upon receipt of electrical current;
at least one wire disposed around the circumference of the at least one window;
the at least one wire operably connected to the at least one window;
the at least one wire connected to a controller;
the controller operably connected to an input console;
the controller electrically connected to a power source.

2) The window transparency control system of claim 1, wherein the at least one wire is transparent.

3) The window transparency control system of claim 1, wherein the at least one wire is low profile.

4) The window transparency control system of claim 1, wherein the controller is operably connected to one or more processors;
the one or more processors operably connected to a non-transitory computer readable medium;
a logic stored in the non-transitory computer readable medium that when executed by the one or more processors causes the power source to adjustably pass current to the at least one wire via the controller.

5) The window transparency control system of claim 4, wherein the one or more processors and the input console are operably connected to a wireless transceiver.

6) The window transparency control system of claim 5, wherein the wireless transceiver is wirelessly connected to a remote control.

7) The window transparency control system of claim 6, wherein the remote control is a key fob.

8) The window transparency control system of claim 6, wherein the remote control is a cellphone.

9) The window transparency control system of claim 1, wherein the controller controls an amount of transparency of each window independently via the selective passing of current to each selected window.

10) The window transparency control system of claim 1, wherein the window transparency control system is disposed in a vehicle.

11) The window transparency control system of claim 10, wherein the controller is configured to keep the front windshield window partially transparent when the car is turned on and electricity is flowing therethrough.

12) The window transparency control system of claim 1, wherein the window transparency control system is disposed in a building.

13) The window transparency control system of claim 1, wherein the power source is a rechargeable battery.

14) The window transparency control system of claim 1, wherein the power source is a car battery.

15) The window transparency control system of claim 1, wherein the power source is a car's electrical system.

16) A method of adjusting the transparency of a window, the method comprising:
coupling at least one wire to a window;
wherein, the window is configured to be adjustably transparent;
receiving an electric current from a power source;
changing the transparency of the window based on the amount of electric current.
